(19) United States
(12) Patent Application Publication
(10) Pub. No.: US 2014/0011168 A1
(43) Pub. Date: Jan. 9, 2014

(54) DEVICE TO PRACTICE AUTOMOTIVE INGRESS AND EGRESS

(71) Applicant: Virginia Mason Medical Center, Seattle, WA (US)

(72) Inventors: Deborah Lee Cutchin, Seattle, WA (US); Jaclyn Ann Subkoviak, Seattle, WA (US); Andrew Marcus LeBeau, Seattle, WA (US); Marcie Lee Larson, Kirkland, WA (US); Adhanom Berhane, Seatac, WA (US); Domi Zhou-Clark, Lynnwood, WA (US)

(21) Appl. No.: 13/934,613

(22) Filed: Jul. 3, 2013

Related U.S. Application Data
(60) Provisional application No. 61/667,828, filed on Jul. 3, 2012.

(51) Int. Cl. G09B 19/00

(52) U.S. Cl. CPC G09B 19/00
USPC 434/247

(57) ABSTRACT

Systems and methods for providing a therapy device configured to mimic the passenger seat of various types of automobiles. The therapy device includes an adjustable ground clearance, an adjustable seat, an adjustable roofline, and a floor plate. The therapy device is portable, lightweight, and compact. Patients may use the therapy device in a physical therapy setting in order to practice getting into and out of a passenger seat that resembles the passenger seat of their own vehicle.

### CROSS REFERENCE TO RELATED APPLICATION

This application claims the benefit of U.S. Provisional Application No. 61/667,828, filed Jul. 3, 2012, the contents of which are incorporated by reference as if set forth in full.

### FIELD OF THE INVENTION

The present invention relates generally to therapy devices, and more particularly, to therapy devices for allowing patients with a new hip or knee (or other condition) to practice entering and exiting a passenger seat of an automobile.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Generally, a patient with a new hip or knee (or other physical condition) has restrictions and limitations that make getting into and out of an automobile a significant challenge. Often, patients with hip or knee replacements are discharged from a medical facility to their home via automobile. Prior to being discharged, these patients are not able to practice the skill of getting into and out of an automobile, so it is often quite difficult to do so for the first time.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1A illustrates a perspective view of a therapy device according to an embodiment of the present invention.

FIG. 1B illustrates a right side elevational view of the therapy device as shown in FIG. 1A.

FIG. 2A illustrates a perspective view of the therapy device when in an raised position.

FIG. 2B illustrates a right side elevational view of the therapy device as shown in FIG. 2A.

FIG. 3A illustrates a perspective view of the therapy device when a seat thereof is in a raised position.

FIG. 3B illustrates a perspective view of the therapy device when the seat is in a raised, tilted rearward position, and a roofline cross bar is in a lowered position.

FIG. 4 illustrates a back left perspective view of the therapy device.

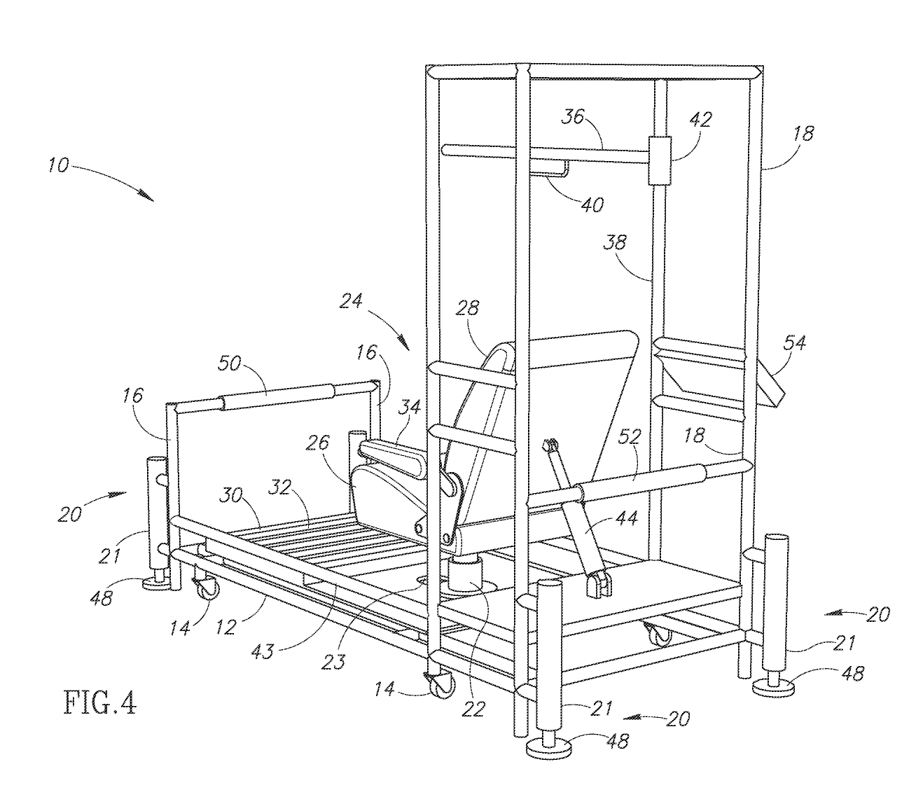

FIG. 5 illustrates a block diagram of a computing device associated with the therapy device.

FIG. 6 illustrates a second embodiment of a therapy device in accordance with an embodiment of the present invention wherein the adjustment of the therapy device is performed by manual adjustment mechanisms.

### DESCRIPTION OF THE INVENTION

One skilled in the art will recognize many methods, systems, and materials similar or equivalent to those described herein, which could be used in the practice of the present invention. Indeed, the present invention is in no way limited to the methods, systems, and materials described.

Embodiments of the present invention are directed to systems and methods for allowing patients with a new hip or knee (or other physical condition) to practice entering and exiting a passenger seat of an automobile similar to their own automobile (or other automobile) in a physical therapy setting. To achieve this, the therapy devices of the present invention are selectively adjustable to mimic the physical characteristics of automobile passenger seats for various types of automobiles. One or more embodiments of the therapy device described herein include the following functional attributes: easy set-up, adjustable, transportable, compact, few moving parts, stable, adjustable legroom, adjustable seat backrest angle, adjustable ground clearance, and a roof and door line.

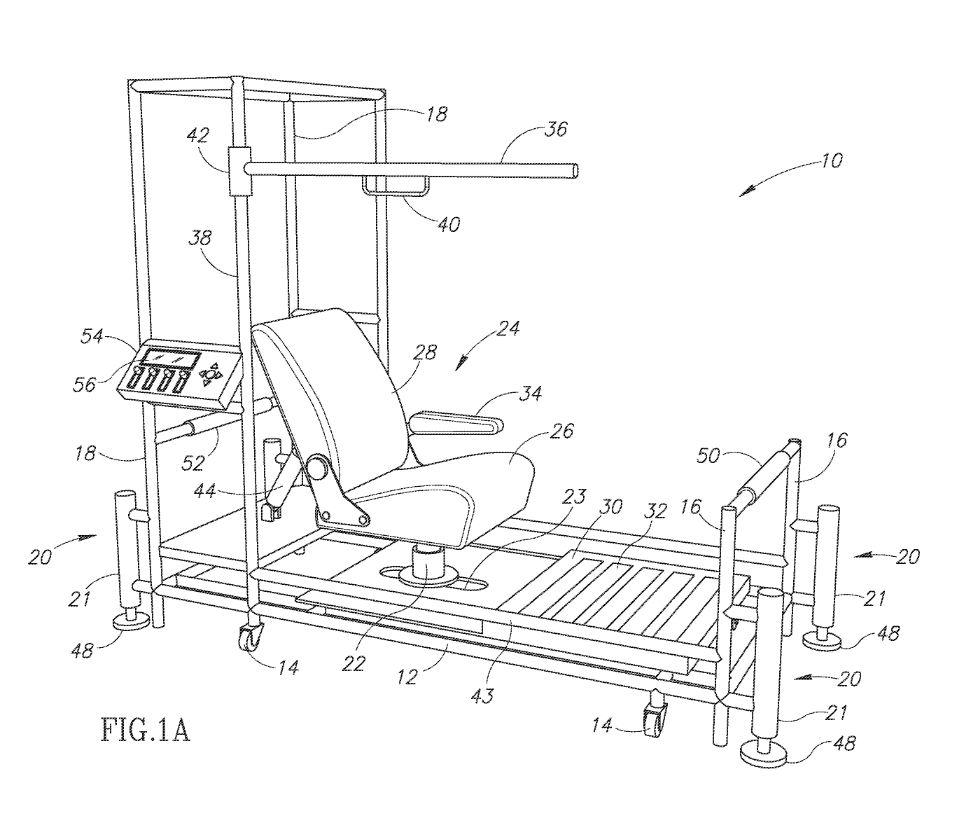

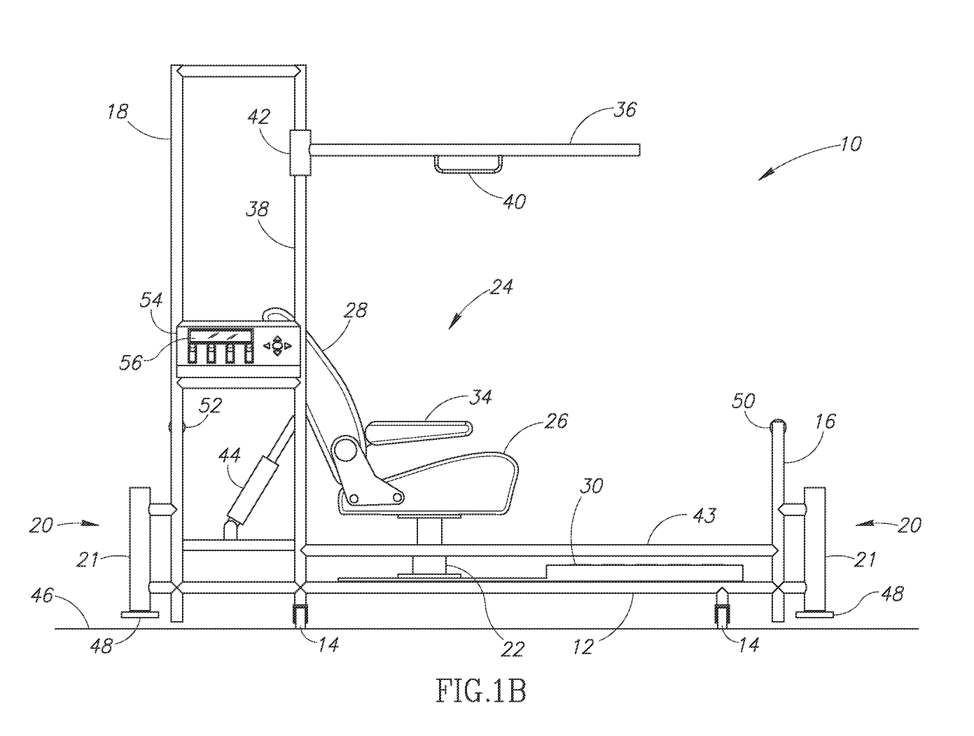

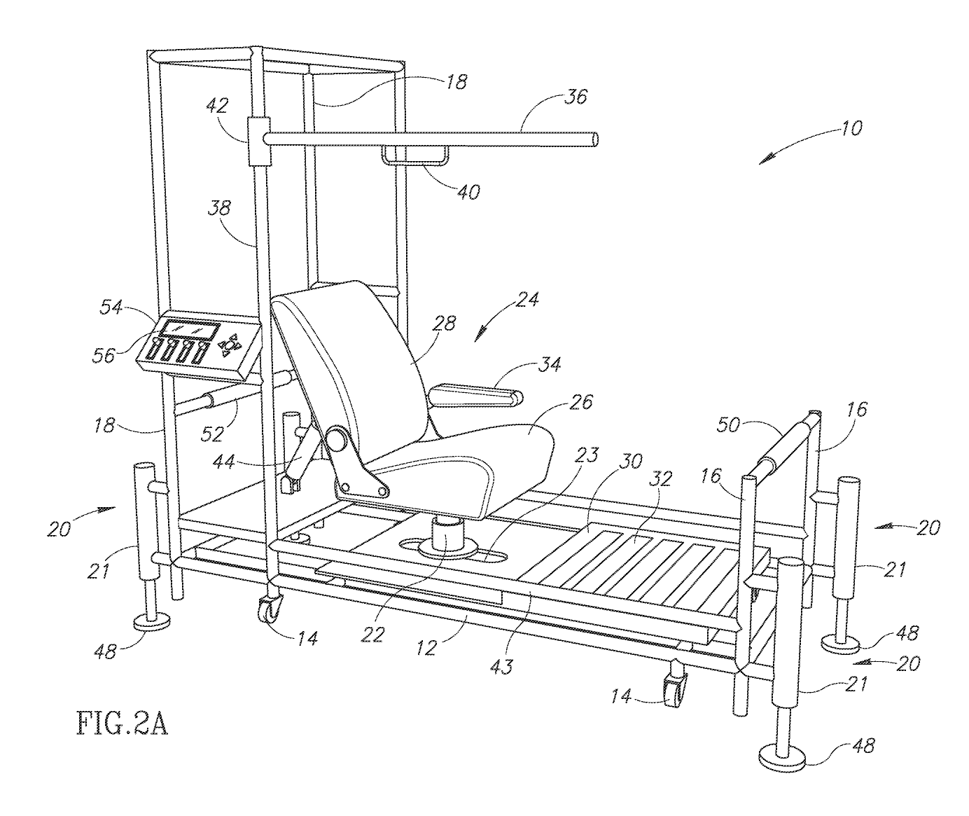

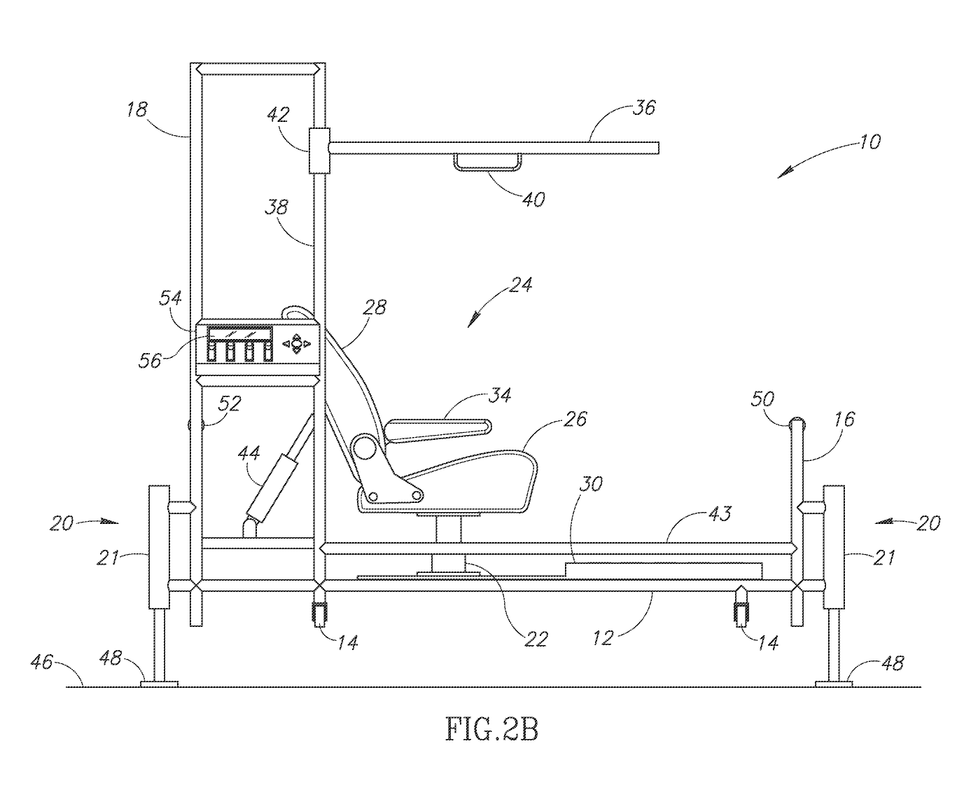

FIGS. 1A-B, 2A-B, 3A-B, and 4 illustrate a therapy device 10 according to an embodiment of the present invention. The therapy device 10 includes a substantially rectangular lower support base or platform 12 supported by four wheels 14. Extending upwardly from the support frame 12 are front frame members 16 and rear frame members 18. Each of the front frame members 16 and the rear frame members 18 are coupled to platform adjustment mechanisms 20 (e.g., pneumatic lifts) comprising a body portion 21 coupled to a selectively extendable base portion 48. Each of the front frame members 16 and the rear frame members 18 are fixedly coupled to a body portion 21 of one of the platform adjustment mechanisms 20. The platform adjustment mechanisms 20 are configured to selectively raise and lower the overall height of the therapy device 10 by selectively extending the base portion 48 from the body portion 21. See FIG. 1B (lowered position) FIG. 2B (raised position). The platform adjustment mechanisms 20 may be operatively coupled to any suitable automatic or manual control device, as described below.

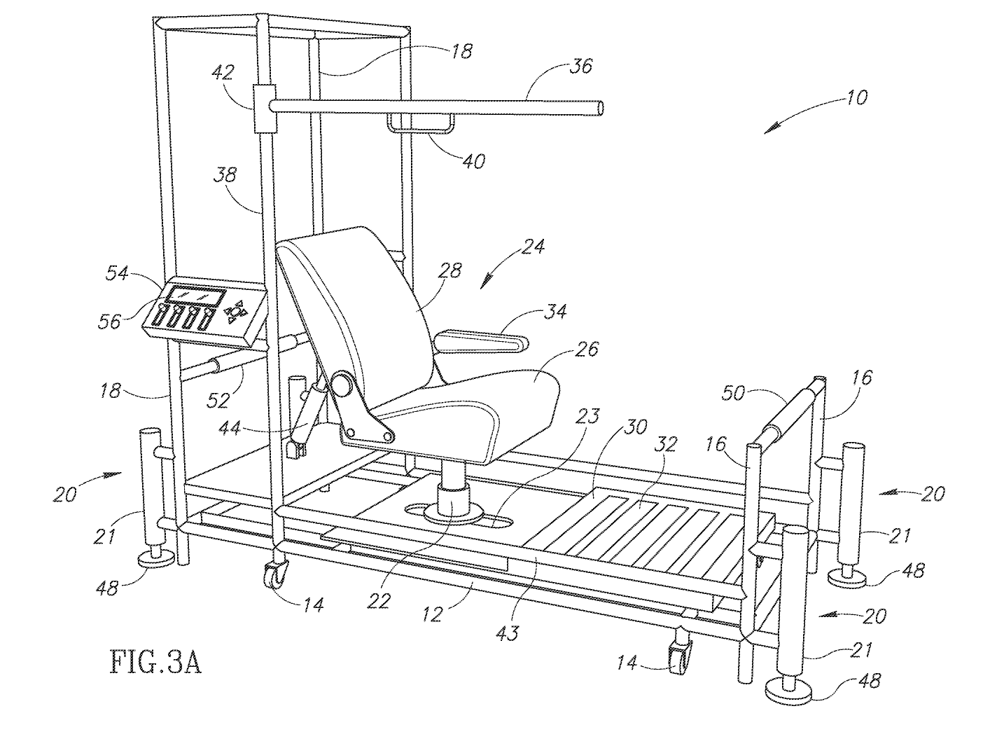

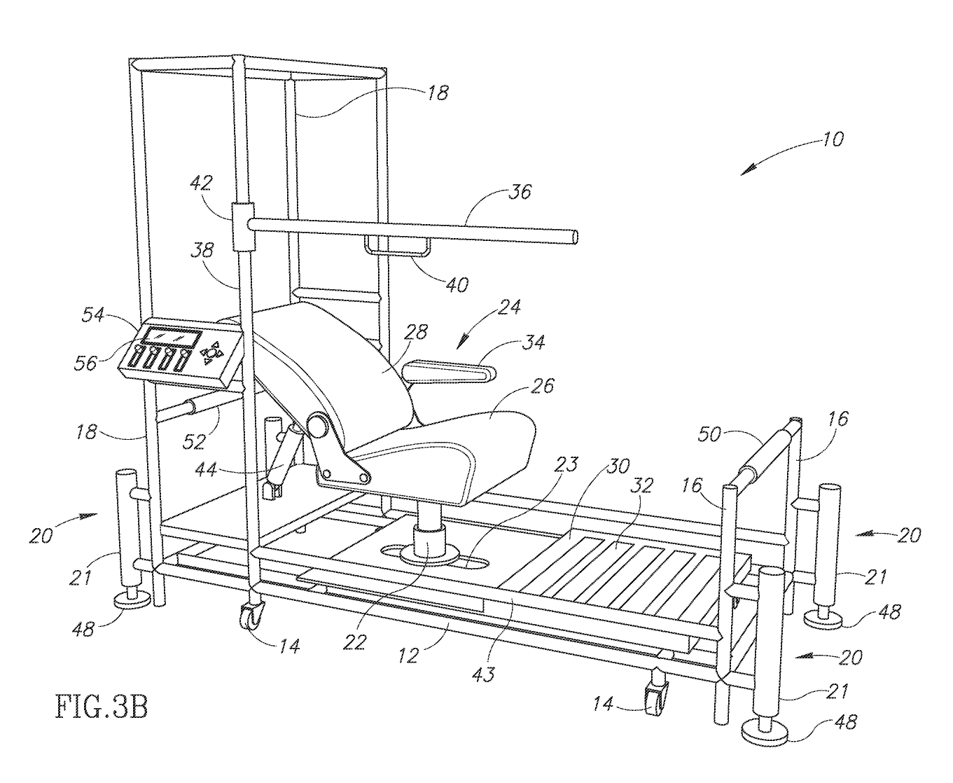

In some embodiments, the therapy device 10 also includes a seat support and adjustment member or mechanism 22 extending upwardly from the lower support platform 12. The seat adjustment mechanism 22 supports a seat 24 by coupling to a seat base 26 thereof. The seat adjustment mechanism is configured to allow the seat 24 to be moved to various heights (compare FIGS. 1A and 3A). In other embodiments, the height of the seat 24 is fixed relative to the platform, which may reduce the complexity (and cost) of the therapy device.

In some embodiments, the seat adjustment mechanism 22 may be movable forward and backward in a slot 23 in the lower support platform 12 to provide for manual or automatic front-to-back adjustability of the seat 24. This feature may or may not be present in some embodiments. The seat 24 also includes an adjustable backrest 28 that has an adjustable angle of between about 45 and 90 degrees, or the like, in one embodiment (compare FIGS. 3A and 3B). In some embodiments, the seat 24 comprises a material configured to meet infection control guidelines.

The therapy device 10 also includes a floor plate 30 coupled to the support frame 12. The floor plate 30 is configured to mimic a floorboard of an automobile. In some embodiments, the floor plate 30 includes a non-stick surface 32 to reduce the likelihood that a patient's foot will slip when using the therapy device 10.

The therapy device 10 also includes a left handle or armrest 34 disposed on a left side of the seat 24 opposite the right side of the seat to mimic an arm rest that a patient may use to pull themselves into a passenger seat of an automobile. In some embodiments, the armrest 34 may be selectively adjustable (e.g., rotatably coupled to the seat 24).

To mimic the roofline of an automobile, the therapy device 10 further includes a horizontal roofline cross bar 36 positioned above the seat 24 and substantially vertically aligned with the right edge of the therapy device 10. The cross bar 36 is supported by a roofline support member 38 that extends upwardly from the lower support frame 12. In some embodiments, the cross bar 36 may be padded. In some embodiments, the cross bar 36 may include a handle 40 configured to mimic the handle present on the interior roof of automobiles adjacent the passenger side door. The patients may use this handle 40 for support when entering and exiting the therapy device 10. The height of the cross bar 36 may be selectively adjustable via a cross bar adjustment mechanism 42 that allows for manual or automatic adjustment of the height of the cross bar. FIG. 3B illustrates the cross bar 36 when in a lower position than that shown in FIG. 3A.

In some embodiments, the therapy device 10 may include a raised horizontal bar 43 positioned along the right side of the platform 12 at a height configured to mimic the lower portion of an automobile door opening that may be at a height greater than the floor plate 30. Thus, the patient must step over the horizontal bar 43 to sit on the seat 24. The height of the horizontal bar 43 may be selectively adjustable in some embodiments.

To enable patients to practice getting into and out of a passenger seat of their own personal automobile, the therapy device 10 is adjustable in several respects. First, as described above, the ground clearance of the therapy device 10 may be adjusted by the platform adjustment mechanisms 20 that are coupled to the front frames 28 and the rear frames 30 (see FIGS. 1B and 2B). For example, if a patient owns a sports utility vehicle (SUV), the ground clearance may be raised so the patient can practice getting into and out of a larger vehicle. Similarly, if a patient owns a sports car, the ground clearance may be lowered. Further, in some embodiments, the height of the seat 24 is adjustable using the seat adjustment mechanism 22, as well as the angle of the backrest 28. The angle of the backrest 28 may be adjustable using a backrest adjustment mechanism 44 coupled between the platform 12 and the backrest that allows for automatic or manual adjustment of the backrest (see FIGS. 3A and 3B). Additionally, as discussed above, in some embodiments the height of the roofline cross bar 36 is also selectively adjustable to better mimic the dimensions of a patient's actual automobile.

By providing the wheels 50, the therapy device 10 is completely portable so it may be transferred across various sections of a medical facility as needed. To accomplish this, the platform adjustment mechanisms 20 may be reduced in height (e.g., by moving the base portions 48 toward body portions 21) until the wheels 50 rest on a support surface (see FIG. 1B) and the base portions 48 of the platform adjustment mechanisms are raised off the support surface, as shown in FIG. 1B. Then, the user can push or pull the therapy device 10 to move it to another location by rolling on the wheels 50. In some embodiments, the therapy device 10 includes a front handle 50 and/or a rear handle 52 to give an operator a place to grasp when pulling or pushing to the therapy device. In some embodiments, the front handle 50 may be sized, shaped, and/or positioned to mimic a dashboard of an automobile to provide a more realistic simulation of an automobile.

By utilizing the therapy device 10, patients are able to practice getting into and out of an automobile that closely matches their own automobile. Thus, once it is time for the patient to be discharged from a medical facility, they are better able to enter and exit their own vehicle (or the vehicle in which they will be driven to their home).

In some embodiments, the adjustability of the various components of the therapy device 10 may be configured to match certain makes and models of vehicles. For example, in one embodiment, a user may select a particular type of vehicle using a computing device 54 comprising a user interface 56, and the platform adjustment mechanisms 20 will automatically adjust the height of the therapy device 10 to match the specified vehicle. Similarly, the roofline cross bar 36, the seat 24, and the backrest 28 may also be automatically or manually adjusted to match known physical dimensions of a vehicle by controlling their respective adjustment mechanisms. To achieve this, the computing device 54 may be operatively coupled to one or more of the adjustment mechanisms 20, 22, 42, and 44 and configured to control their operation.

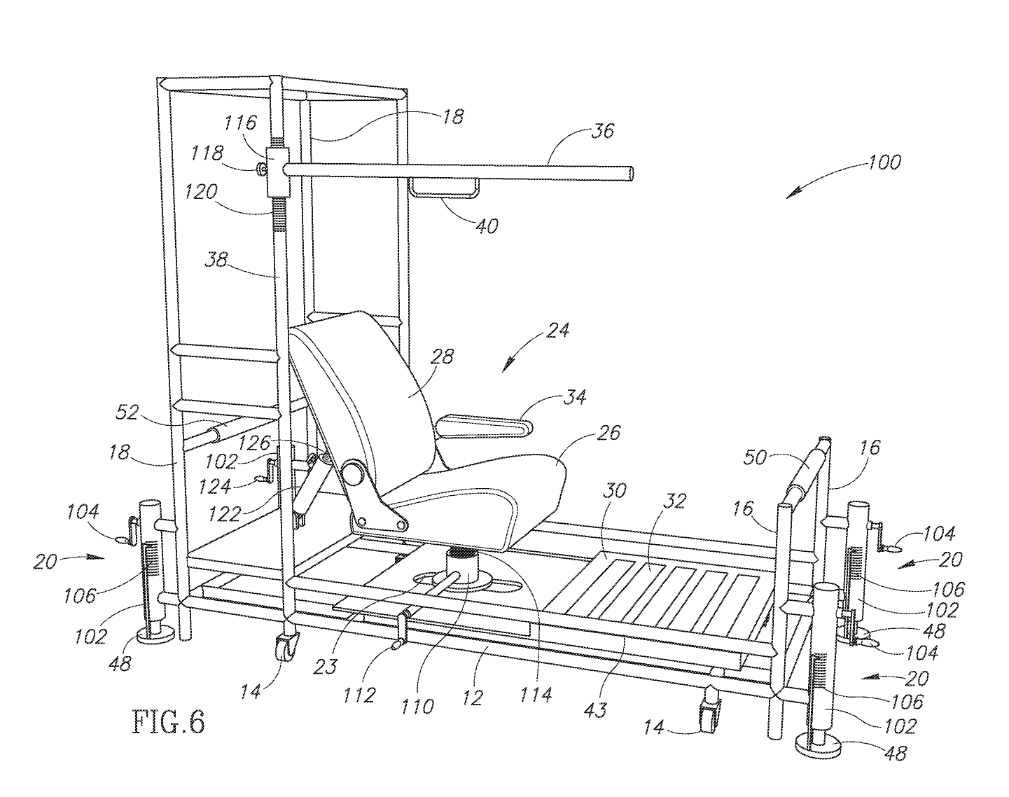

In some embodiments, the physical dimensions of various vehicles may be stored in the computing device 54 so that the adjustments to the various components of the therapy device 10 may be automatically performed upon selection of a vehicle type. In other embodiments, the components of the therapy device 10 may include visible features or markings (see FIG. 6) that provide an adjustment guide to the user relating to the appropriate position of each component for different types of vehicles. Those skilled in the art will readily recognize that there are several ways to selectively adjust the various components of the therapy device 10 in order to approximately match the physical dimensions of a particular vehicle of a patient.

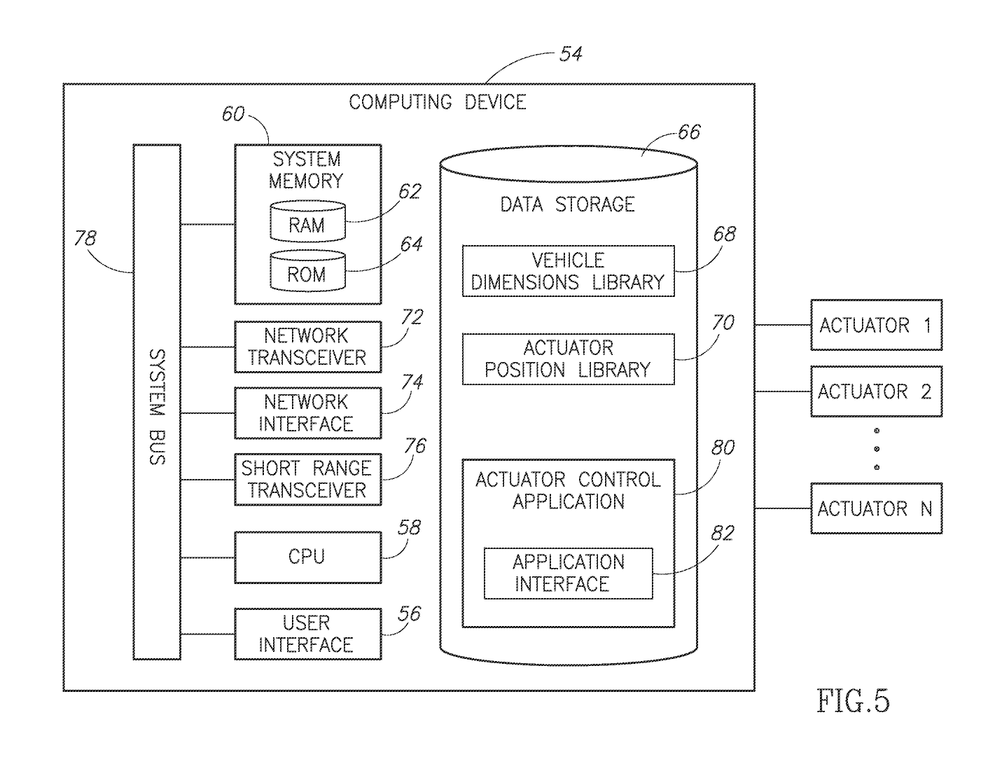

FIG. 5 shows a block diagram view of the computing device 54. The computing device may include, but is not limited to, one or more processor devices including a central processing unit (CPU) 58. The CPU 58 may be responsible for executing computer programs stored on the computing device's system memory 60, which may include volatile (RAM) memory 62 and nonvolatile (ROM) memory 64. The computing device 10 may also include the user interface 56 that allows a user to interact with the computing device's software and hardware resources. The user interface 56 may include various inputs (e.g., keyboard, mouse, touchscreen, microphone, etc.) and outputs (e.g., display, speakers, etc.).

The computing device 54 further includes a system data storage structure 66 that includes applications and/or application plug-ins (e.g., client applications, etc.) that may facilitate a user of the computing device interacting with various other entities over one or more wired and/or wireless data communication networks.

The system data storage structure 66 may also include a vehicle dimensions library 68 that includes a data storage of the physical dimensions of various automobiles (e.g., seat height, roofline height, etc.).

The computing device 54 may also include an actuator position library module 70 configured to store the various possible positions for each of a plurality of actuators 1, 2, . . . N (e.g., platform adjustment mechanisms 20, seat adjustment mechanism 22, backrest adjustment mechanism 44, cross bar adjustment mechanism 42, etc.) used to make adjustments for the therapy device 10.

The computing device 54 may also include a network transceiver 72 and a network interface 74 that allow the computing device to communicate across a data communications network (e.g., the Internet). The computing device 54 may also include an optional short-range transceiver 76 (e.g., a Bluetooth® or a Wi-Fi® enabled communications transceiver) that allows the computing device to wirelessly communicate with one or more electronic devices. Further, the computing device 54 may include a system bus 78 that facilitates data communications amongst all the hardware resources of the computing device.

The system data storage structure 66 of the computing device 54 also includes a client application 80 including an application interface 82 for allowing the user to selectively control the position of the actuators 1, 2, . . . , N to adjust the physical dimensions of the therapy device 10. For example, a user may input or select a certain type of car (e.g., 2009 Ford Explorer, 2012 Toyota Camry, etc.). The application 80 may then fetch the selected vehicle's dimensions from the vehicle dimensions library 68, then adjust the positions of the actuators 1, 2, . . . , N to mimic the dimensions of the selected vehicle. In some embodiments, the user may also select the positioning of the actuators directly using the interface without selecting a vehicle, and the application will adjust the actuators accordingly. Using these components, the client application 80 is operative to send movement instructions to the actuators 1, 2, . . . , N. Using the user interface 56 and the application interface 82, the user can also update or modify the vehicle dimensions library 68 (e.g., to include additional vehicle dimensions). Additionally or alternatively, the data stored in the data storage 66 may be periodically updated via a remote or local connection (e.g., updates downloaded from a server, etc.).

FIG. 6 illustrates another embodiment of a therapy device 100 in accordance with an embodiment of the present invention. The therapy device 100 is substantially similar to the therapy device 10 in many respects. However, in this embodiment, the therapy device 100 is adjustable using a plurality of manual adjustment mechanisms. For example, the therapy device 100 includes platform adjustment mechanisms 102 that include manual actuators 104 (e.g., cranks) that allow a user to selectively adjust the position of the platform adjustment mechanisms and therefore the height of the platform 12. The platform adjustment mechanisms 102 include markings 106 that allow a user to determine the position of each of the platform adjustment mechanisms. Similarly, the seat 24 may include a seat adjustment mechanism 110 that includes a manual actuator 112 (e.g., a crank) that allows a user to selectively adjust the position of the seat adjustment mechanism and therefore the height of the seat. The seat adjustment mechanism 110 includes markings 114 that allow a user to determine the position of the seat adjustment mechanism. Further, the cross bar 36 may include a cross bar adjustment mechanism 116 that is manually adjustable via an actuator 118 (e.g., a knob, pin, etc.), and markings 120 indicating the position of the cross bar. Additionally, the backrest 28 of the seat 24 may be coupled to a backrest adjustment mechanism 122 that includes a manual actuator 124 and a plurality of position markings 126.

It should be appreciated that the therapy devices 10 and 100 may include any combination of manual and computer controlled adjustment mechanisms. Further, other types of adjustment mechanisms may be used without departing from the scope of the embodiments of the present invention. For example, adjustment mechanisms may be manual, automatic, mechanical, electrical, pneumatic, hydraulic, or any other suitable type.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

What is claimed is:

1. A therapy device to practice automotive ingress and egress, comprising:
a platform;
a plurality of wheels positioned below the platform configured to support the platform on a support surface and to permit the therapy device to be transported between various locations by rolling the plurality of wheels on the support surface;
a seat coupled to the platform; and
a platform height adjustment mechanism coupled to the platform configured to selectively move between a first position wherein the platform height adjustment mechanism is spaced above the support surface of the therapy device and the plurality of wheels are in contact with the support surface to permit movement of the therapy device, and a second position wherein the platform height adjustment mechanism is in contact with the support surface and the plurality of wheels are spaced above the support surface, wherein in the second position, the platform height adjustment mechanism supports the platform on the support surface.

2. The therapy device of claim 1, further comprising a seat angle adjustment mechanism operative to selectively adjust the angle of a seat backrest of the seat.

3. The therapy device of claim 1, further comprising a cross bar disposed on a right side of the therapy device and positioned at a height above the seat, wherein the cross bar is configured to mimic a roofline of an automobile.

4. The therapy device of claim 3, wherein the height of the cross bar is selectively adjustable.

5. The therapy device of claim 3, further comprising a cross bar support member extending upwardly from the platform, wherein the cross bar is coupled to the cross bar support member.

6. The therapy device of claim 3, wherein the cross bar includes a handle.

7. The therapy device of claim 3, further comprising a cross bar adjustment mechanism coupled to the cross bar and configured to selectively adjust the height thereof.

8. The therapy device of claim 7, further comprising a computing device operatively coupled to the cross bar adjustment mechanism, the computing device being operative to selectively adjust the height of the cross bar by controlling the operation of the cross bar adjustment mechanism.

9. The therapy device of claim 1, wherein the platform height adjustment mechanism comprises a pneumatic lift.

10. The therapy device of claim 1, wherein, when in the second position, the platform height adjustment mechanism may selectively adjust the height of the platform.

11. The therapy device of claim 1, further comprising a computing device operatively coupled to the platform height adjustment mechanism, the computing device being operative to selectively adjust the height of the platform by controlling the operation of the platform height adjustment mechanism.

12. The therapy device of claim 11, wherein the computing device is operatively coupled to a seat adjustment mechanism coupled to the seat and configured to adjust at least one of the height of the seat relative to a top surface of the platform and the front-to-back position of the seat, the computing device being operative to selectively adjust the position of the seat by controlling the operation of the seat adjustment mechanism.

13. The therapy device of claim 1, further comprising a computing device operatively coupled to a seat adjustment mechanism coupled to the seat and configured to adjust at least one of the height of the seat relative to a top surface of the platform and the front-to-back position of the seat, the computing device being operative to selectively adjust the position of the seat by controlling the operation of the seat adjustment mechanism.

14. A therapy device to practice automotive ingress and egress, comprising:
a base;
a plurality of wheels positioned below the base configured to support the base on a support surface and to permit the therapy device to be transported between various locations by rolling the plurality of wheels on the support surface;
a seat coupled to the base via a seat adjustment mechanism, the seat adjustment mechanism configured to adjust the height of the seat relative to a top surface of the base;
a base adjustment mechanism coupled to the base configured to selectively move between a first position wherein the base adjustment mechanism is spaced above the support surface and the plurality of wheels are in contact with the support surface to permit movement of the therapy device, and a second position wherein the base adjustment mechanism is in contact with the support surface and the plurality of wheels are spaced above the support surface, wherein in the second position, the base adjustment mechanism supports the base on the support surface; and
a computing device operatively coupled to the seat adjustment mechanism and the base adjustment mechanism, the computing device being operative to control the operation of the seat adjustment mechanism and the base adjustment mechanism.

15. The therapy device of claim 14, wherein the computing device stores vehicle data comprising, for a plurality of vehicles, a corresponding position of the seat adjustment mechanism and the base adjustment mechanism.

16. The therapy device of claim 15, wherein the computing device comprises a user interface that permits a user to select one of the plurality of vehicles stored in the computing device, and the computing device is operative to adjust the positions of the seat adjustment mechanism and the base adjustment mechanism according to the vehicle data stored for the selected vehicle.

17. The therapy device of claim 14, further comprising:
a cross bar coupled to the base and positioned above the seat and to the right thereof to mimic a roofline; and
a cross bar adjustment mechanism coupled to the cross bar and configured to adjust the height of the cross bar;
wherein the computing device is operatively coupled to the cross bar adjustment mechanism and configured to control the operation thereof.

18. The therapy device of claim 14, wherein the computing device includes a user interface that allows a user to selectively control the height of the seat and the height of the base by controlling the seat adjustment mechanism and the base adjustment mechanism.

19. A computer-implemented method for permitting the practice of automobile ingress and egress, comprising:
providing a therapy device comprising:
a base;
a plurality of wheels positioned below the base configured to support the base on a support surface and to permit the therapy device to be transported between various locations by rolling the plurality of wheels on the support surface;
a seat coupled to the base via a seat adjustment mechanism, the seat adjustment mechanism configured to adjust the height of the seat relative to a top surface of the base;
a base adjustment mechanism coupled to the base configured to selectively move between a first position wherein the base adjustment mechanism is spaced above the support surface and the plurality of wheels are in contact with the support surface to permit movement of the therapy device, and a second position wherein the base adjustment mechanism is in contact with the support surface and the plurality of wheels are spaced above the support surface, wherein in the second position, the base adjustment mechanism supports the base on the support surface; and
a computing device operatively coupled to the seat adjustment mechanism and the base adjustment mechanism, the computing device being operative to control the operation of the seat adjustment mechanism and the base adjustment mechanism, the computing device comprising a user interface; and
operating the user interface to cause the computing device to control the operation of the seat adjustment mechanism and the base adjustment mechanism.
